(19) United States
(12) Patent Application Publication
(10) Pub. No.: US 2025/0172104 A1
(43) Pub. Date: May 29, 2025

(54) APPARATUS AND METHOD FOR MANAGING AUTOIGNITION IN AN IN-CYLINDER INJECTOR AND COMBUSTION CHAMBER OF AN INTERNAL COMBUSTION ENGINE

(71) Applicant: HPDI Technology Limited Partnership, Vancouver (CA)

(72) Inventors: Jian Huang, Surrey (CA); Sandeep Munshi, Delta (CA)

(73) Assignee: HPDI Technology Limited Partnership, Vancouver, BC (CA)

(21) Appl. No.: 18/868,694

(22) PCT Filed: May 25, 2023
(86) PCT No.: PCT/CA2023/050719

§ 371 Date: Nov. 22, 2024

Related U.S. Application Data
(60) Provisional application No. 63/345,889, filed on May 25, 2022.

(51) Int. Cl. F02D 41/14; F02D 41/30; F02D 41/40

(52) U.S. Cl. CPC F02D 41/1498; F02D 41/3076; F02D 41/403

(57) ABSTRACT

An apparatus for managing ignition in a chamber of an in-cylinder injector that introduces a fuel directly into a combustion chamber of an internal combustion engine. The chamber includes an injection hole in fluid communication with the combustion chamber. A controller connected with the in-cylinder injector is programmed to actuate the in-cylinder injector to inject the fuel; determine whether autoignition is possible in the chamber as a function of operating parameters; and perform a mitigation strategy to prevent autoignition within the chamber when autoignition is possible.

### FIELD OF THE INVENTION

The present application relates to an apparatus and method for managing autoignition conditions in an in-cylinder injector and a combustion chamber of an internal combustion engine, and more particularly for reducing and preferably preventing the likelihood of autoignition in the in-cylinder injector and selectively enhancing the likelihood of autoignition in the combustion chamber.

### BACKGROUND OF THE INVENTION

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Late-cycle, direct-injection of gaseous fuel into combustion chambers of internal combustion engines, where the fuel burns in a diffusion combustion mode (also referred to as diesel-cycle engines), offers several benefits over premixed, gaseous-fuel engines including high thermal efficiency, combustion stability, and knock free operation. As used herein, a gaseous fuel is any fuel that is in the gas state at standard temperature and pressure conditions, where standard temperature is a temperature of zero degrees Celsius (0° C.) and standard pressure is an absolute pressure of 1 bar. In-cylinder injectors are employed to inject the gaseous fuel directly into respective combustion chambers since the gaseous fuel is injected after an intake valve is closed in the late-cycle engines. A nozzle of the in-cylinder injector extends into the combustion chamber and accordingly is exposed to the elevated temperatures that exist during combustion of the gaseous fuel.

The thermal efficiency of internal combustion engines can be improved by increasing the compression ratio. The compression ratio is defined as the ratio between the volume of the combustion chamber at its maximum volume (particularly at the point the intake valve closes during or after the intake stroke) over its minimum volume (particularly at top dead center at the end of the compression stroke). As the compression ratio increases both the temperature and pressure in the combustion chamber at the end of the compression stroke increase, and with all else remaining the same the peak combustion temperature and peak cylinder pressure (PCP) will also increase.

For a diesel-cycle engine operating with a high compression ratio the temperature and pressure environment inside a sac of the in-cylinder injector can be such that any residual fuel and charge mixture in the sac can reach an autoignition condition before the normal injection starts. The sac is a chamber within the in-cylinder injector between an injection valve and one or more injection holes in the nozzle. The burning of the residual fuel within the sac can create rapid rise of pressure and temperature inside the sac volume that can lead to increased stress and wear on the nozzle of the in-cylinder injector, which can reduce the operating life of the injector.

The type of fuel can also influence the thermal load on the in-cylinder injector. For example, a flame lift-off distance for hydrogen gas jets emanating from an injection hole of the nozzle is shorter than that of a natural gas jet or diesel spray due to the high flame speed of hydrogen. In this regard, the thermal load on the in-cylinder injector tip, especially around the injection holes, is substantially higher than that for natural gas or diesel. The high thermal load can lead to reduced metal strength that contributes to a reduction in the operating life of the injector.

The state of the art is lacking in techniques for thermal management of nozzles of in-cylinder injectors, and particularly for nozzles of in-cylinder injectors operating in a high compression ratio environment and/or injecting fuels with high flame speed. The present apparatus and method provide techniques for thermal management of nozzles of in-cylinder injectors, and particularly for managing autoignition conditions in a chamber of an in-cylinder injector and in a combustion chamber of an internal combustion engine.

### SUMMARY OF THE INVENTION

An improved apparatus for managing ignition in a chamber within an in-cylinder injector that introduces a fuel directly into a combustion chamber of an internal combustion engine. The chamber can include at least one injection hole and can be in fluid communication with the combustion chamber through the at least one injection hole. The apparatus includes a controller operatively connected with the in-cylinder injector and programmed to selectively actuate the in-cylinder injector to inject the fuel directly into the combustion chamber; determine whether autoignition is possible within the chamber as a function of engine operating parameters; and perform a mitigation strategy to prevent autoignition within the chamber of the in-cylinder injector when autoignition is possible.

The controller can be further programmed to employ a standard engine map when autoignition is not possible, and to employ a modified engine map when autoignition is possible. The engine operating parameters can be one or more of geometric compression ratio, effective compression ratio, fuel type, fuel composition, intake charge temperature, inlet manifold pressure, inlet manifold temperature, exhaust gas recirculation concentration, engine speed, and engine load. The fuel can be hydrogen, natural gas, mixtures of hydrogen and natural gas, or mixtures of hydrogen and other gaseous fuels.

In performing the mitigation strategy, the controller can be programmed to determine a critical crank angle during a compression stroke when autoignition becomes possible in the chamber; determine a mitigation quantity of the fuel required to be injected before the critical crank angle to prevent autoignition in the chamber; and actuate the in-cylinder injector to perform a mitigation injection of the mitigation quantity of the fuel before the critical crank angle is reached by a piston traveling in the combustion chamber during the compression stroke. The mitigation quantity of the fuel reduces the likelihood and preferably prevents autoignition in the chamber at least until a main injection of the fuel occurs later during the compression stroke. Alternatively, or additionally, in performing the mitigation strategy, the controller can be programmed to determine a critical compression ratio that creates a pressure and temperature environment in the chamber suitable for autoignition; and adjust the effective compression ratio such that the effective compression ratio is less than the critical compression ratio. The critical compression ratio can be calculated as a function of at least one engine operating parameter selected from the group consisting of fuel type, fuel composition, intake charge temperature, inlet manifold pressure, inlet manifold temperature, exhaust gas recirculation concentration, engine speed, and engine load. Alternatively, or additionally, in performing the mitigation strategy, the controller can be programmed to increase a coolant flow through a charge-air-cooler to decrease an inlet manifold temperature or an intake charge temperature at the beginning of the compression stroke.

The controller can be further programmed to perform a second mitigation strategy when autoignition of the fuel is not possible within the combustion chamber. In performing the second mitigation strategy, the controller can be programmed to determine a critical compression ratio that creates a pressure and temperature environment in the combustion chamber suitable for autoignition; and adjust the effective compression ratio such that the effective compression ratio is greater than or equal to the critical compression ratio. Alternatively, or additionally, in performing the second mitigation strategy, the controller can be programmed to decrease a coolant flow through a charge-air-cooler to increase an inlet manifold temperature or an intake charge temperature at the beginning of the compression stroke.

An improved method for managing ignition in a chamber within an in-cylinder injector that introduces a fuel directly into a combustion chamber of an internal combustion engine. The chamber can include at least one injection hole and can be in fluid communication with the combustion chamber through the at least one injection hole. The method includes determining whether autoignition is possible within the chamber as a function of engine operating parameters; and performing a mitigation strategy to reduce the likelihood and preferably prevent autoignition within the chamber of the in-cylinder injector when autoignition is possible. A standard engine map can be employed when autoignition is not possible, and a modified engine map can be employed when autoignition is possible. The engine operating parameters can be one or more of geometric compression ratio, effective compression ratio, fuel type, fuel composition, intake charge temperature, inlet manifold pressure, inlet manifold temperature, exhaust gas recirculation concentration, engine speed, and engine load.

The mitigation strategy can include determining a critical crank angle during a compression stroke when autoignition becomes possible in the chamber; determining a mitigation quantity of the fuel required to be injected before the critical crank angle to prevent autoignition in the chamber; and performing a mitigation injection of the mitigation quantity of the fuel before the critical crank angle is reached by a piston traveling in the combustion chamber during the compression stroke. The mitigation quantity of the fuel reduces the likelihood and preferably prevents autoignition in the chamber at least until a main injection of the fuel occurs later during the compression stroke. Alternatively, or additionally, the mitigation strategy can include determining a critical compression ratio that creates a pressure and temperature environment in the chamber suitable for autoignition; and adjusting the effective compression ratio such that the effective compression ratio is less than the critical compression ratio. The critical compression ratio can be calculated as a function of at least one engine operating parameter selected from the group consisting of fuel type, fuel composition, intake charge temperature, inlet manifold pressure, inlet manifold temperature, exhaust gas recirculation concentration, engine speed, and engine load. Alternatively, or additionally, the mitigation strategy can include increasing a coolant flow through a charge-air-cooler to decrease an inlet manifold temperature or an intake charge temperature at the beginning of the compression stroke.

In the method, a second mitigation strategy can be performed when autoignition of the fuel is not possible within the combustion chamber. The second mitigation strategy can include determining a critical compression ratio that creates a pressure and temperature environment in the combustion chamber suitable for autoignition; and adjusting the effective compression ratio such that the effective compression ratio is greater than or equal to the critical compression ratio. Alternatively, or additionally, the second mitigation strategy can include decreasing a coolant flow through a charge-air-cooler to increase an inlet manifold temperature or an intake charge temperature at the beginning of the compression stroke.

### BRIEF DESCRIPTION OF THE DRAWINGS

The accompanying drawings, which are incorporated into and constitute a part of the specification, illustrate specific embodiments of the apparatus, systems, and methods and, together with the general description above, and the detailed description of the specific embodiments, serve to explain the principles of the apparatus, systems, and methods.

FIG. 1 is a cross-sectional view of a combustion chamber of an internal combustion engine according to an embodiment.

FIG. 2 is a partial cross-sectional view of a prior art nozzle of an in-cylinder injector employed in the internal combustion engine of FIG. 1.

FIG. 3 is a cross-sectional view of a combustion chamber of an internal combustion engine according to another embodiment.

FIG. 4 is a partial cross-sectional view of a prior art nozzle of an in-cylinder injector employed in the internal combustion engine of FIG. 3.

FIG. 5 is a chart view illustrating a 500-microsecond delay limit of a main fuel employed in the internal combustion engines of FIGS. 1 and 3 for fuel-air equivalence ratios of 0.5, 1.0, 1.5, and 2.0 and illustrating end of compression pressure and temperature conditions for normalized compression ratios of 1.0, 0.913, 0.826, and 0.739 where for each normalized compression ratio a common beginning of compression temperature and a range of beginning of compression pressures between 0.5 and 3.0 bar are employed.

FIG. 6 is a flow chart of an algorithm for mitigating autoignition in a main sac of the in-cylinder injectors of FIGS. 2 and 4.

FIG. 7 is a flow chart of an algorithm for a mitigation strategy employing a mitigation injection for the algorithm of FIG. 6.

FIG. 8 is a chart view of injection flow rates for a mitigation injection, a pilot injection, and a main injection employed in the algorithm of FIG. 7 for the internal combustion engine of FIG. 1.

FIG. 9 is a chart view of injection flow rates for a mitigation injection and a main injection employed in the algorithm of FIG. 7 for the internal combustion engine of FIG. 3.

FIG. 10 is a flow chart of an algorithm for a mitigation strategy employing changes in the effective compression ratio for the algorithm of FIG. 6.

FIG. 11 is a flow chart of an algorithm for a mitigation strategy employing changes in inlet manifold temperature for the algorithm of FIG. 6.

FIG. 12 is a flow chart of an algorithm for preventing autoignition in a main sac of the in-cylinder injectors of FIGS. 2 and 4 and enhancing autoignition in a combustion chamber of the internal combustion engines of FIGS. 1 and 3, respectively.

FIG. 13 is a flow chart of an algorithm for an autoignition-enhancing mitigation strategy employing changes in the effective compression ratio for the algorithm of FIG. 12.

FIG. 14 is a flow chart of an algorithm for an autoignition-enhancing mitigation strategy employing changes in the inlet manifold temperature for the algorithm of FIG. 12.

FIG. 15 is a flow chart of an algorithm for determining whether to operate the internal combustion engines of FIGS. 1 and 3 in a monofuel-autoignition mode or a forced ignition mode.

### DETAILED DESCRIPTION OF EXEMPLARY EMBODIMENT(S)

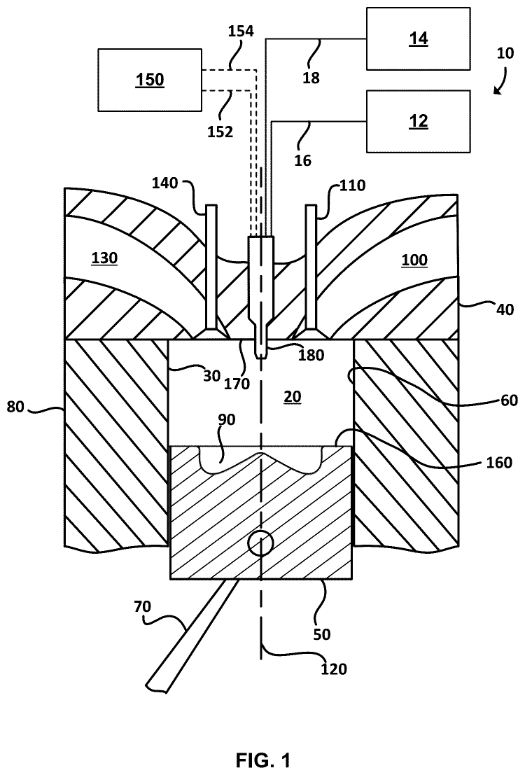

Referring to FIG. 1, there is shown internal combustion engine 10 in simplified form to facilitate the understanding of the present techniques. Engine 10 is shown with one cylinder in the illustrated embodiment and where in other embodiments there can be more than one cylinder.

Combustion chamber 20 is formed by cylinder wall 30, cylinder head 40 and piston 50. Piston 50 reciprocates within cylinder 60 whereby piston rod 70 connects piston 50 with a crankshaft (not shown) and converts reciprocal motion of piston 50 into circular motion of the crankshaft. Cylinder wall 30 forms a bore in engine block 80 that can be any size (diameter) suitable for internal combustion engines. For example, in light duty engine applications the bore size is typically less than 100 mm, in medium and heavy-duty engine applications the bore size can range from 100 mm to 180 mm, and in high horsepower engine applications the bore size is above 180 mm. Generally, as the bore size increases the maximum engine speed decreases, primarily due to the increase in momentum of the piston that accompanies increases in its mass and speed putting increased stress on engine components, as would be known by those skilled in the technology.

Piston 50 includes piston bowl 90 in its crown that faces cylinder head 40. An air handling system includes intake port 100 and intake valve 110, which are configured to cooperate with cylinder 60, cylinder head 40 and piston 50 to ingress intake air into combustion chamber 20 and establish a bulk motion of the intake charge therein. The bulk motion of intake charge (also referred to as main charge motion) can be a swirl motion where the intake charge revolves around longitudinal axis 120, a tumble motion where the intake charge revolves around an axis orthogonal to longitudinal axis 120, or a combination of swirl motion and tumble motion. For diesel-cycle engines, the main charge motion is usually swirl since diesel-cycle engines typically have a flat cylinder head and a piston bowl shape that do not support tumble motion. Alternatively, a quiescent combustion chamber can be established where a quiescent combustion chamber refers herein to a combustion chamber in which there is negligible swirl or tumble of an intake charge therein, and preferably none. The air handling system further includes exhaust port 130 and exhaust valve 140, and, as would be known to those familiar with the technology, other components common in air handling systems that are not illustrated in the figures can be included, such as for example a turbocharger including a turbine in fluid communication with the exhaust for driving a compressor for selectively compressing intake air and a charge-air-cooler for cooling the turbo-compressed intake air, as well as an aftertreatment system for reducing pollutants out a tailpipe. Intake valve 110 and exhaust valve 140 can be actuated in a variety of ways, such as by cams driven by engine 10 or electronically actuated by electronic controller 150. In some embodiments intake valve 110 and exhaust valve 140 are actuated by a variable valve timing (VVT) system or a variable valve actuation (VVA) system (both not shown) whereby the timing of the opening and closing of the valves 110 and 140 can be adjusted. At the top dead center (TDC) position, there is a small gap (not shown) between top land surface 160 of piston 50 and fire deck 170. At this position with some embodiments valves 110 and 140 can be aligned with recessed portions (not shown) in piston 50 so that the valves can be in an open position without interference with the piston.

In-cylinder injector 180 is shown mounted in cylinder head 40 and introduces a main fuel directly into combustion chamber 20. As used herein, the main fuel can be hydrogen, natural gas, mixtures of hydrogen and natural gas, or mixtures of hydrogen and other gaseous fuels. Although in-cylinder injector 180 is shown centrally mounted, it is possible that the injector can be mounted offset from longitudinal axis 120 of cylinder 60 or mounted through cylinder wall 30 instead of cylinder head 40 in other embodiments. That is, this specific location of the fuel injector is not essential to the disclosed apparatus, and the mounting location can be determined by the specific architecture of an engine and the available space. In the illustrated embodiment, in-cylinder injector 180 further introduces a pilot fuel, such as diesel, into combustion chamber 20, which is compression ignitable due to the temperature and pressure created during the compression stroke of piston 50. The pilot fuel acts as a high energy ignition source to ignite the main fuel and is a type of forced ignition. The main fuel is supplied to in-cylinder injector 180 from main fuel supply 12 through conduit 16 and the pilot fuel is supplied to in-cylinder injector 180 from pilot fuel supply 14 through conduit 18. In the illustrated embodiment in-cylinder injector 180 is a concentric needle fuel injector that can introduce the pilot fuel separately and independently of the main fuel. In alternative embodiments, in-cylinder injector 180 can comprise one body with side-by-side main fuel and pilot fuel injection assemblies, or separate fuel injectors can be employed to introduce the main fuel and the pilot fuel directly into combustion chamber 20. Controller 150 is operatively connected with in-cylinder injector 180 to actuate the in-cylinder injector over connection 152 to introduce the main fuel directly into combustion chamber 20 and to actuate the in-cylinder injector over connection 154 to introduce pilot fuel directly into combustion chamber 20. In-cylinder injector 180 is actuatable to introduce the pilot fuel independently and separately from the main fuel, and the timing of the injections of the pilot fuel and the main fuel are determined based on engine operating conditions and may or may not overlap. In other embodiments the main fuel can be ignited by another type of forced ignition instead of by the pilot fuel, such as a spark plug, a glow plug or other heated surface, a microwave ignition apparatus, and a laser igniter. When a fuel is ignited by forced ignition, the ignition source is also referred to as a positive ignition source. The pilot fuel usually contains significantly more energy and is distributed by the injection into various locations in the combustion chamber, and in contrast the spark plug or glow plug is a low energy, single point ignition source.

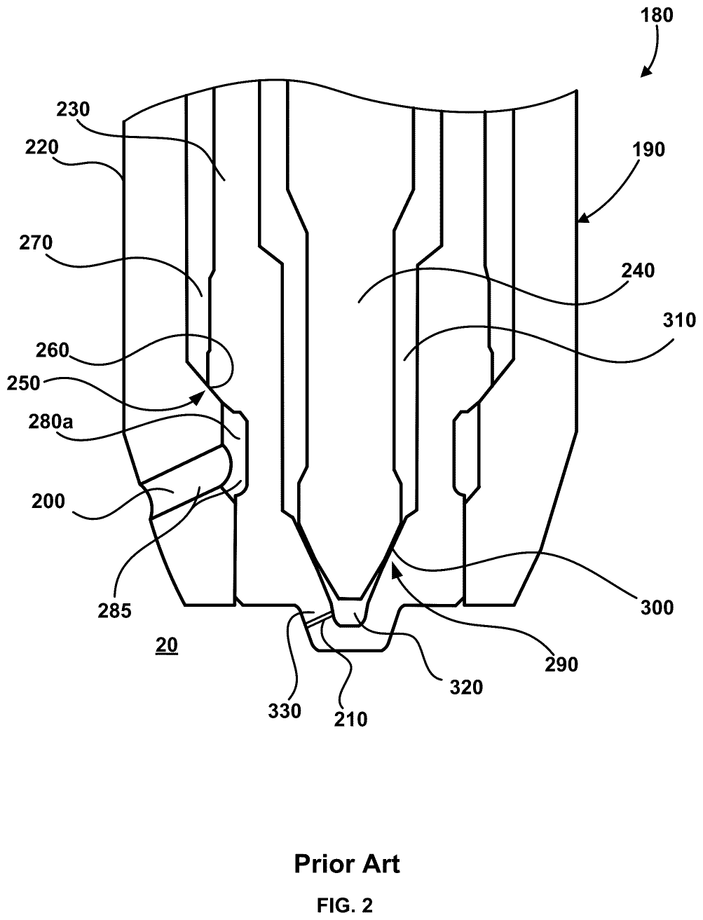

Referring now to FIG. 2, in-cylinder injector 180 is described in more detail. Nozzle 190 extends into combustion chamber 20, includes main injection hole 200 for introducing the main fuel and pilot injection hole 210 for introducing the pilot fuel by way of a concentric needle arrangement. Only nozzle 190 of in-cylinder injector 180 is illustrated in FIG. 2, and a more detailed description of similar dual fuel injectors can be found in the Applicant's U.S. Pat. No. 10,294,908 issued May 21, 2019 and U.S. Pat. No. 10,502,169 issued Dec. 10, 2019; both of which are hereby incorporated by reference. Valve body 220, which may include one or more parts, encapsulates fuel injector 180 and includes known structures for housing respective actuator assemblies for main valve member 230 and pilot valve member 240, and inlets for receiving the main fuel and the pilot fuel and conduits for delivering the main and pilot fuels to the illustrated nozzle portion of valve body 220. Main valve member 230, also known as a hollow needle or sleeve, is actuatable for reciprocating movement within valve body 220. Main valve member 230 is made to reciprocate to open and close main injection valve 250 where in a closed position main valve member 230 abuts main valve seat 260 and in an open position main valve member 230 is spaced apart from main valve seat 260. When main injection valve 250 is open the main fuel stored in plenum 270 flows through the main injection valve into main sac 280a and is introduced into combustion chamber 20 through main injection hole 200 formed in valve body 220. Main sac 280a is a chamber in in-cylinder injector 180 downstream from main injection valve 250 and which is in fluid communication with combustion chamber 20 through at least one main injection hole 200. Although only one main injection hole 200 is illustrated in the cross section shown in FIG. 2 it is understood by those familiar with the technology that there is typically a plurality of main injection holes, for example spaced around a perimeter of nozzle 190. In the illustrated in-cylinder injector 180, plenum 270 and main sac 280a are annular cavities formed between valve body 220 and main valve member 230. Pilot valve member 240, also known as a needle, is actuatable for reciprocating movement within the hollow interior of main valve member 230. Pilot valve member 240 is made to reciprocate to open and close pilot injection valve 290 where in a closed position pilot valve member 240 abuts pilot valve seat 300 and in an open position pilot valve member 240 is spaced apart from pilot valve seat 300. When pilot injection valve 290 is open the pilot fuel stored in plenum 310 flows through the pilot injection valve into pilot sac 320 and is introduced into combustion chamber 20 through pilot injection hole 210 formed in tip wall 330, which in the illustrated embodiment is part of main valve member 230. Although only one pilot injection hole 210 is illustrated in the cross section shown in FIG. 2, it is understood by those familiar with the technology that there is typically a plurality of pilot injection holes, for example spaced around the perimeter. In the illustrated in-cylinder injector 180, plenum 310 is an annular cavity formed between main valve member 230 and pilot valve member 240, and pilot sac 320 is a chamber downstream from pilot injection valve 290 defined by main valve member 230 and pilot valve member 240. In an exemplary embodiment main and pilot valve members 230 and 240, respectively, of in-cylinder injector 180 are hydraulically actuated and the pilot fuel performs a dual function as a hydraulic fluid. Main and pilot valve members 230 and 240 can also be electrically actuated and made to move directly by magnetic forces in alternative embodiments.

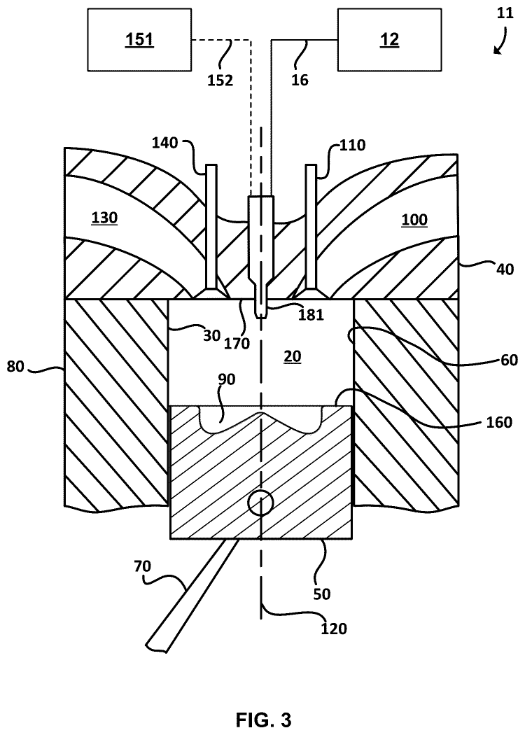

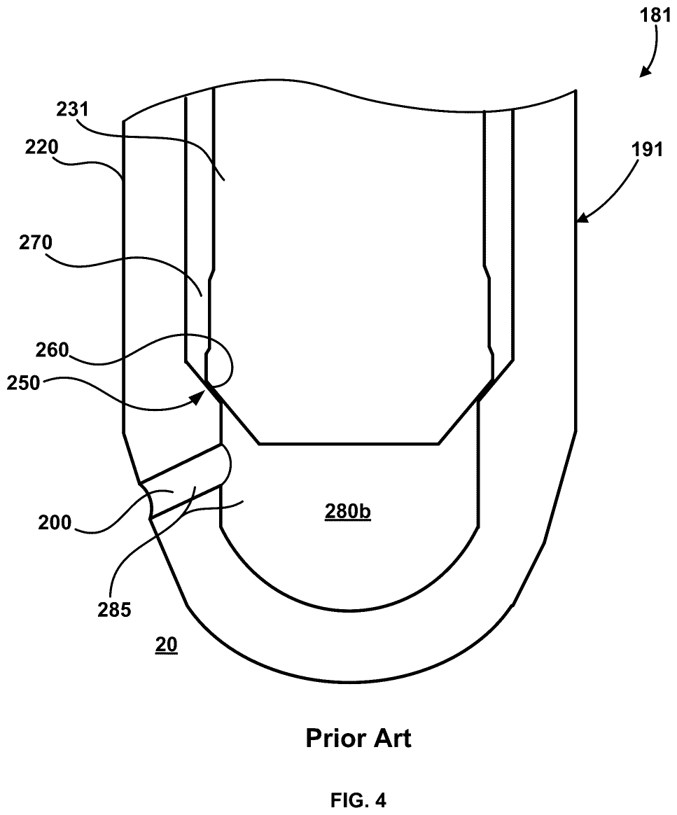

Referring now to FIG. 3, there is shown internal combustion engine 11 in simplified form according to another embodiment where like parts to previous and all other embodiments have like reference numerals and may not be described in more detail and generally only differences are discussed. In-cylinder injector 181 is a monofuel injector that only introduces the main fuel directly into combustion chamber 20. With reference to FIG. 4, nozzle 191 of in-cylinder injector 181 is shown in more detail. Main valve member 231 is a needle in the illustrated embodiment, and although main valve member 231 could be a hollow needle like main valve member 230 in in-cylinder injector 180, it is not required to be since there is no pilot valve member concentrically aligned with main valve member 231 in in-cylinder injector 181. Main sac 280b in FIG. 4 is a chamber that is not an annular chamber like main sac 280a in FIG. 2, and although these two chambers are different geometries they are herein referred to as main sac 280 for case of reference.

Under certain conditions any main fuel that is present in main sac 280a and main injection hole 200 in in-cylinder injector 180 or in main sac 280b and main injection hole 200 in in-cylinder injector 181 can be ignited prior to main fuel injection, which can create a rapid rise in pressure and temperature inside nozzles 190 and 191, respectively and lead to increased stress and wear on the nozzles that in the worst case can cause failure of in-cylinder injectors 180 and 181. As used herein, chamber 285 refers to main sac 280a and main injection hole 200 in in-cylinder injector 180 and to main sac 280b and main injection hole 200 in in-cylinder injector 181. A computational fluid dynamics model of engine 10 was created and an assessment was performed to determine the concentration of residual main fuel (for example, hydrogen) within chamber 285. It was determined that any residual main fuel remaining in chamber 285 at the beginning of the compression stroke diffused out of chamber 285 into combustion chamber 20 as piston 50 moved upwards towards TDC such that the fuel-air mixture within chamber 285 became too lean to ignite during a preignition window in the compression stroke where conditions were favorable for autoignition. As used herein, the preignition window in relation to chamber 285 is a period during the compression stroke (defined by a starting crank angle and an ending crank angle) during which the pressure and temperature environment within chamber 285 can maintain the ignitable mixture at an autoignition temperature for a period equal to or longer than an ignition delay associated with the main fuel. The preignition window can extend into the expansion stroke, where in the absence of combustion pressure and temperature conditions at the end of compression begin to decline during the expansion stroke such that favorable autoignition conditions may exist for a brief period at the beginning of the expansion stroke. This led to the understanding that the source of the main fuel within chamber 285 was not primarily residual fuel from a previous combustion cycle. Remarkably, it was determined that the source of the main fuel within chamber 285 that led to autoignition before fuel injection was the main fuel leaking through main injection valve 250 with enough of a leakage flow rate to create an ignitable mixture within chamber 285 during the preignition window. For conventional gaseous fuels employed in late-cycle, direct injection, diesel-cycle engines, such as natural gas, when injection valve 250 is closed the leakage flow rate therethrough is below a level required to create an ignitable mixture in chamber 285. However, when gaseous fuels such as hydrogen are used it is more difficult to seal hydrogen under high pressure conditions since the size of the hydrogen diatomic molecule (H2) is significantly smaller compared to the methane molecule (CH4), where methane is the largest constituent of natural gas. Consequently, the leakage flow rate of hydrogen through injection valve 250 when closed is more likely to exceed a level to prevent an ignitable mixture from forming within chamber 285 that can be ignited during the preignition window. It is noteworthy to indicate that an ignitable mixture within chamber 285 includes both fuel and an oxidant, such as oxygen.

Primary factors that determine whether autoignition occurs in chamber 285 is the compression ratio, the intake charge temperature (ICT) and the intake charge pressure (ICP) both at the beginning of the compression stroke, and fuel type or composition. The ICT and the compression ratio together determine the end of compression temperature, and the ICP and compression ratio together determine the end of compression pressure, and it is the temperature and pressure conditions throughout the compression stroke that determine whether autoignition conditions exist. Higher compression ratio leads to higher end of compression temperature and pressure, which increases the thermal load on nozzles 190 and 191 thereby raising the temperature and pressure conditions within chamber 285. The compression ratio can be a geometric compression ratio or an effective compression ratio. The geometric compression ratio is the maximum compression ratio achievable in a particular internal combustion engine and is defined as the ratio between a maximum volume of combustion chamber 20 when piston 50 is at or near bottom dead center when the intake valve closes (during the intake stroke or the compression stroke) over a volume of combustion chamber 20 when piston 50 is at top dead center. The effective compression ratio is less than or equal to the geometric compression ratio, which can be achieved by adjusting intake valve closing timing using VVT or VVA and can be defined as a ratio between a volume of combustion chamber 20 when intake valve 110 closes during the intake stroke or the compression stroke (where exhaust valve 140 is already closed) over a volume of combustion chamber 20 when piston 50 is at top dead center. The effective compression ratio can also take into account blowby of charge through piston rings (not shown), where the piston rings are disposed between piston 50 and cylinder 60 and seal combustion chamber 20. The geometric compression ratio and the available effective compression ratio values are programmed in controllers 150 and 151 herein, whereby the current compression ratio is known by these controllers. The higher the ICT and ICP the higher the temperature and pressure, respectively in the combustion chamber throughout the compression stroke. Certain fuels possess higher flame speeds and therefore their fuel jets exhibit a shorter flame lift-off distance from nozzles 190 and 191 of in-cylinder injectors 180 and 181, respectively compared to fuels with lower flame speeds. As used herein, flame lift-off distance of a fuel jet refers to the shortest distance measured along a path of the fuel jet between an opening of an injection hole from which the fuel jet emanates to where the fuel jet is combusting (that is, the closest distance the flame of the combusting fuel jet is to the injection hole). Shorter lift-off distances can lead to increased thermal load on nozzles 190 and 191 thereby increasing their temperatures, including the interior temperature within chamber 285. The fuel type or composition can also be programmed into controllers 150 and 151; however, in some embodiments two more types of fuel or a fuel of varying composition may be employed in internal combustion engines 10 and 11 whereby the fuel type or composition may need to be determined during operation. Under these circumstances various techniques can be employed to determine a heating value of the fuel, and the heating value can be employed to determine the fuel type or composition by inference, such as using an oxygen sensor to detect residual oxygen in the exhaust, using a hot wire sensor in fuel conduits to detect the thermal properties of the fuel, and using an accelerometer to detect ignition and combustion properties in the combustion chambers are just a few examples. It is understood that controllers 150 and 151 are also aware of the fuel type and/or composition with which internal combustion engines 10 and 11 are currently being fueled. Secondary factors that influence autoignition in chamber 285 include inlet manifold pressure (IMP), inlet manifold temperature (IMT), exhaust gas recirculation (EGR) concentration, engine speed and engine load. The higher the IMP and IMT, the more likely autoignition will occur in chamber 285, whereas the higher the EGR concentration the less likely preignition will occur. Generally, EGR concentration has a minor impact on ignition delay and affects flame temperature and flame speed significantly more. These engine operating condition parameters (IMP, IMT, EGR concentration, engine speed, engine load) are conventional parameters that are measured and available to electronic controllers in conventional internal combustion engines, and which are made available to controllers 150 and 151 herein.

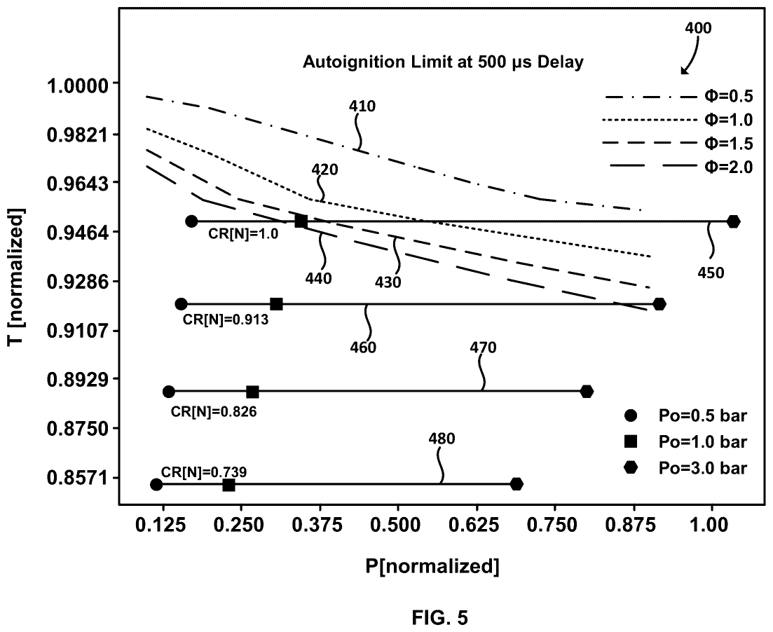

Referring now to FIG. 5 chart view 400 illustrates the autoignition limit at 500 microseconds (μs) delay for a variety of fuel/air equivalence ratios (also known as phi with symbol ϕ) plotted against normalized values of temperature and pressure. Lines 410, 420, 430, and 440 represent the 500-microsecond delay limit for fuel-air mixtures having fuel/air equivalence ratios (ϕ) of 0.5, 1.0, 1.5, and 2.0, respectively. A fuel/air equivalence ratio below 1.0 represents a lean fuel-air mixture (where there is more oxygen than needed to burn all the fuel), a fuel/air equivalence ratio equal to 1.0 represents a stoichiometric fuel-air mixture (where there is just enough oxygen available to burn all the fuel), and a fuel/air equivalence ratio above 1.0 represents a rich fuel-air mixture (where there is not enough oxygen available to burn all the fuel). For each fuel/air equivalence ratio, the area above lines 410, 420, 430, and 440 represents conditions more favorable for autoignition, and the area below line 410, 420, 430, and 440 represents conditions that are less favorable, and which eventually prevent autoignition. More particularly, the autoignition delay increases for temperature and pressure points further below respective lines 410, 420, 430, and 440. It is understood that in an internal combustion engine there is a limited opportunity for ignition to occur (during the preignition window) in the sense that the temperature and pressure in combustion chamber 20 (and chamber 285) increases during the compression stroke and then begins to decrease during the expansion stroke (after piston 50 passes TDC at the end of the compression stroke) in the absence of combustion. At least a portion of the main fuel in either combustion chamber 20 or chamber 285 must reach a temperature and pressure condition suitable for autoignition and then sustain that condition for the autoignition delay before it can ignite. As an example, in a 4-stroke engine running at 2000 revolutions per minute, the compression stroke lasts for 15 milliseconds (ms); however the preignition window is a fraction of this time since both the temperature and pressure must first increase to a condition that makes autoignition possible, and then this condition must be sustained for the autoignition delay before ignition can occur. Typically, a maximum autoignition delay in heavy duty, internal combustion engines is around 1-2 ms depending on engine speed. As can be seen in FIG. 5, as the fuel/air equivalence ratio increases (becomes richer) the temperature required for autoignition decreases for a given pressure. However, at some point the mixture becomes too rich to burn, and similarly as the mixture increasingly becomes leaner it eventually becomes too lean to burn. It is suspected that before the fuel-air mixture reaches the upper flammability limit where it is too rich to burn in chamber 285, the temperature of the fuel-air mixture in chamber 285 decreases due to a cooling effect of the main fuel leaking through main injection valve 250 thereby creating conditions where autoignition is not possible. Each horizontal line 450, 460, 470, and 480 represents end of compression temperature and pressure conditions for a unique compression ratio (each compression ratio is represented with a normalized value in the chart), where the compression ratios of the lines in decreasing order are line 450, 460, 470, and 480. Each horizontal line 450, 460, 470, and 480 has one end of compression temperature but a range of end of compression pressures. In this regard, each horizontal line 450, 460, 470, and 480 represents one in-cylinder temperature at the start of compression (inside combustion chamber 20) and a plurality of in-cylinder pressures at the start of compression. For each horizontal line 450, 460, 470, and 480, the initial combustion chamber pressure increases from left to right, where three cases (P_{O}=0.5 bar, 1.0 bar, and 3.0 bar) for each line are illustrated, such that the end of compression pressure increases from left to right as well. As can be seen, the pressure and temperature conditions along line 450 present several possible conditions that permit autoignition within chamber 285 for the richer equivalence ratios (ϕ=1.0, 1.5, and 2.0), since the area above portions of lines 420, 430, and 440 includes parts of line 450. On the other hand, the pressure and temperature conditions along lines 460, 470, and 480 do not present several possible conditions that permit autoignition within chamber 285 for the illustrated equivalence ratios, since the area above lines 410, 420, 430, and 440 do not (at least substantially) include parts of lines 460, 470, and 480.

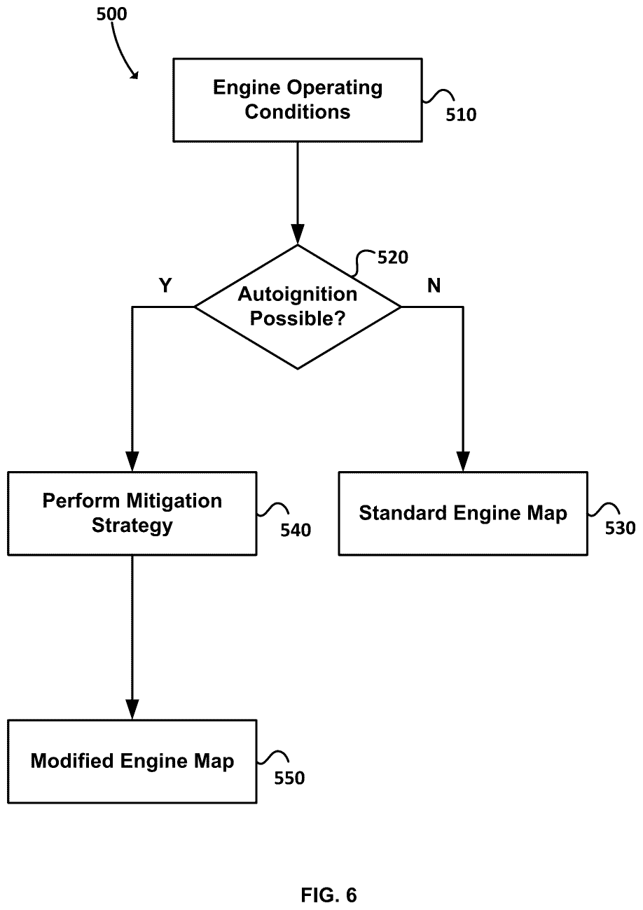

Referring now to FIG. 6, there is shown a flow chart of algorithm 500 for mitigating autoignition within chamber 285. Algorithm 500 and all other algorithms disclosed herein can be carried out by controller 150 in engine 10 of FIG. 1 and controller 151 in engine 11 of FIG. 3. One or more engine operating condition parameters are collected in step 510 and input into step 520 where it is determined whether autoignition is possible within chamber 285. The engine operating condition parameters used in step 520 can be selected from the group consisting of compression ratio, fuel type or composition, ICT, IMP, IMT, EGR concentration, engine speed, and engine load. Fuel injection is performed according to standard engine map 530 when autoignition is not possible within chamber 285, where the standard engine map can include any of the following injection parameters including injection timing, injection quantity, injection pressure, number of injection pulses, pulse width for each pulse, and separation between pulses, where these injection parameters can be based on engine operating conditions. More particularly, standard engine map 530 includes both pilot fuel injection timing and injection quantity information and main fuel injection timing and injection quantity information, based on engine operating conditions, when employed for engine 10; and standard engine map 530 includes main fuel injection timing and injection quantity information, based on engine operating conditions, when employed for engine 11. Mitigation strategy 540 is performed when autoignition is possible within chamber 285, where the mitigation strategy reduces the likelihood and preferably prevents autoignition from occurring in chamber 285. Fuel injection is performed with modified engine map 550 after or during mitigating for autoignition. Similarly, modified engine map 550 can include the same injection parameter information as standard engine map 530, such as for example injection timing and injection quantity information for the pilot fuel and/or the main fuel, depending upon for which engine 10 or 11 the modified engine map 550 is employed. The injection parameter information can change between standard engine map 530 and modified engine map 550, particularly when the mitigation strategy 540 includes injection of the main fuel (as will be discussed in more detail below), although there may be circumstances when some or all of the injection parameter information does not change for the same engine operating conditions.

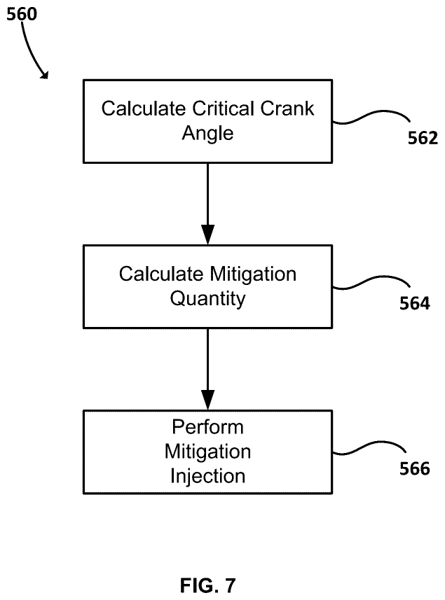

Referring now to FIG. 7, there is shown a flow chart of an algorithm 560 that can be employed for mitigation strategy 540 in the algorithm 500 of FIG. 6. A critical crank angle is calculated in step 562. The critical crank angle is the earliest crank angle during the compression stroke from which it is possible for autoignition to occur. As discussed above, an ignitable fuel-air mixture within chamber 285 must be maintained at an autoignition temperature (within a pressure and temperature environment suitable for autoignition) for a period equal to the autoignition delay for the ignitable fuel-air mixture to ignite. The critical crank angle represents the point during the compression stroke in which this condition becomes possible and marks the beginning of the preignition window that can end at the latest during the expansion stroke (as discussed in more detail above). The critical crank angle can be calculated as a function of the engine operating condition parameters employed to determine whether autoignition in the chamber 285 is possible, which can include one or more of the parameters including the compression ratio, the fuel type or composition, IMP, IMT, EGR concentration, engine speed, and engine load. A mitigation quantity of main fuel is calculated in step 564 that represents the quantity of main fuel required to be injected into combustion chamber 20 through chamber 285 prior to the critical crank angle to prevent autoignition within chamber 285. Autoignition can be prevented in chamber 285 for the remainder of the current engine cycle. Alternatively, autoignition in chamber 285 can be prevented at least until a main injection of the main fuel occurs later during the current compression stroke. The injection of the mitigation quantity of main fuel makes the fuel-air mixture (if any air remains) within chamber 285 unignitable. The fuel-air mixture becomes unignitable for a variety of reasons. Preferably, the oxidant in chamber 285 is flushed out of the main sac into combustion chamber 20 by the injection of the mitigation quantity of main fuel such that there is no oxidant present in the main sac after the injection. It is also possible that a new fuel-air mixture is formed in chamber 285 that is too rich to burn (that is, some oxidant remains in chamber 285). Alternatively, the injection of the mitigation quantity of main fuel may cool the fuel-air mixture such that the new fuel-air mixture that forms is below the autoignition temperature. The injection of the mitigation quantity of main fuel is performed in step 566 before piston 50 reaches the critical crank angle. In other embodiments, there can be more than one mitigation injection of the main fuel before the primary injection of main fuel occurs.

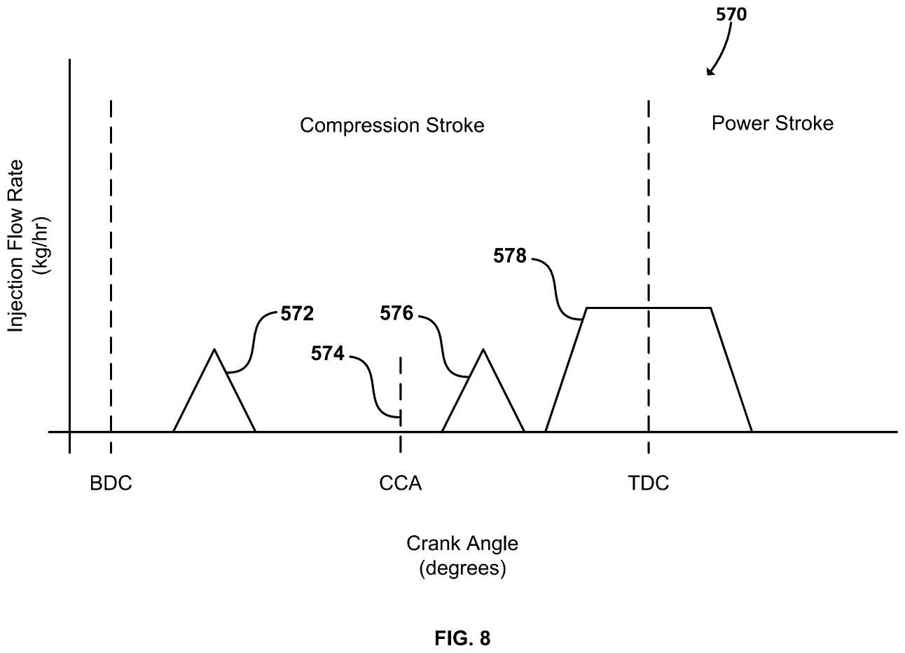

With reference to FIG. 8, a chart view 570 illustrating fuel injection flow rates when algorithm 560 of FIG. 7 is employed in algorithm 500 of FIG. 6 for internal combustion engine 10 of FIG. 1. Mitigation injection 572 of the mitigation quantity of main fuel is performed before piston 50 reaches critical crank angle 574 to purge chamber 285 of oxygen thereby forming a fuel-air mixture that is too rich to burn (and preferably that is void of an oxidant) to prevent autoignition within the main sac. Mitigation injection 572 of main fuel also lowers the temperature within chamber 285 by cooling the fuel-air mixture therein, which also reduces the likelihood of autoignition within the main sac. Critical crank angle 574 is the crank angle during the compression stroke at which point forward autoignition within chamber 285 is possible when both fuel and oxidant are present therein and measures are not taken to prevent autoignition, and where autoignition will not occur within chamber 285 when an ignitable fuel-air mixture is present therein before the critical crank angle. Critical crank angle 574 can be a function of the primary factors (compression ratio and fuel type or composition), and additionally, can also be a function of the secondary factors (IMP, IMT, EGR concentration, engine speed, engine load). Following mitigation injection 572 and typically after critical crank angle 574, pilot injection 576 of the pilot fuel and main injection 578 of the main fuel are performed. In the illustrated embodiment, pilot injection 576 precedes main injection 578; however, this is not a requirement and various timings of the pilot injection and the main injection can be employed. Returning to FIG. 6, standard engine map 530 also includes a quantity of main fuel to be injected and ignited by a pilot injection that is related to a total quantity of main fuel injected in the context of the injection strategy of FIG. 8. The quantity of main fuel injected in standard engine map 530 is substantially equal to a sum of the main fuel injected by mitigation injection 572 and main injection 578 (seen in FIG. 8) in modified engine map 550.

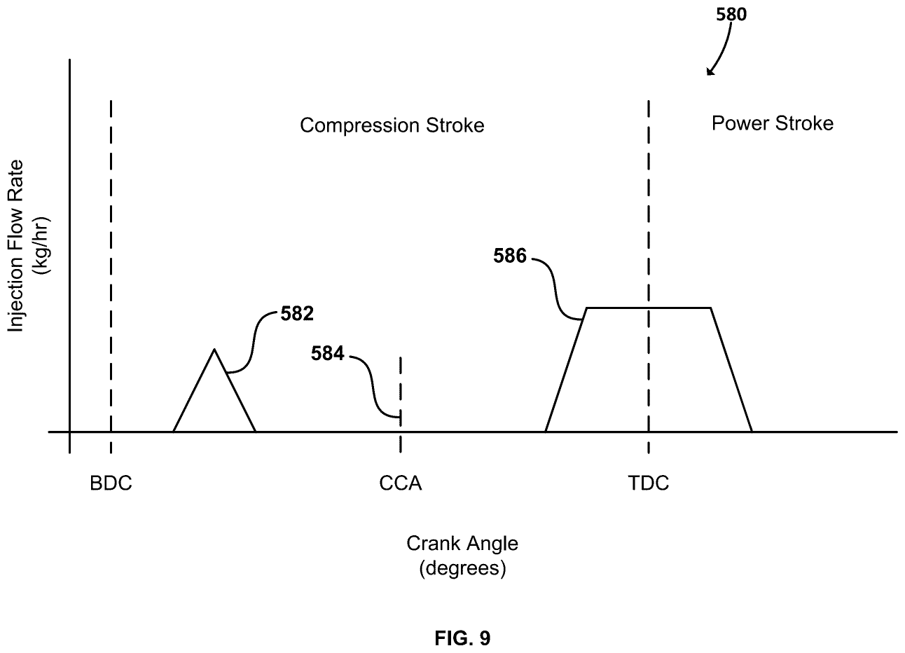

With reference to FIG. 9, a chart view 580 illustrating fuel injection flow rates when algorithm 560 of FIG. 7 is employed in algorithm 500 of FIG. 6 for internal combustion engine 11 of FIG. 3. Engine 11 is a monofuel engine and accordingly does not employ combustion of a pilot fuel to ignite the main fuel. Instead, ignition of the main fuel is by way of autoignition of the main fuel in combustion chamber 20 when a suitable pressure and temperature environment is created therein. To ensure that a fuel-air mixture in chamber 285 does not pre-ignite before the injection of the main fuel, mitigation injection 582 of a mitigation quantity of main fuel is performed before critical crank angle 584 (calculated in the same manner as discussed above) to evacuate oxygen from chamber 285 and/or cool the fuel-air mixture therein. The portion of the fuel from mitigation injection 582 of the mitigation quantity of main fuel that enters combustion chamber 20 can auto-ignite and improve the pressure and temperature environment in combustion chamber 20 for the ignition of the main fuel introduced by main injection 586. That is, mitigation injection 582 can operate as a pilot injection of the main fuel the combustion of which improves the ability of the main fuel introduced by main injection 586 to ignite. However, it is not a requirement that the combustion of the mitigation injection is required for the ignition of the main fuel by the main injection. Returning to FIG. 6, standard engine map 530 also includes a quantity of main fuel to be injected and ignited by autoignition that is related to a total quantity of main fuel injected in the context of FIG. 9. Typically, when autoignition is possible in combustion chamber 20 it is also possible in chamber 285. In this regard, mitigation injection 582 it typically employed, although there may be engine operating conditions where autoignition is not possible within chamber 285 before main injection 586. In general, the quantity of main fuel injected in standard engine map 530 is substantially equal to a sum of the main fuel injected by mitigation injection 582 and main injection 586 (seen in FIG. 9) in modified engine map 550.

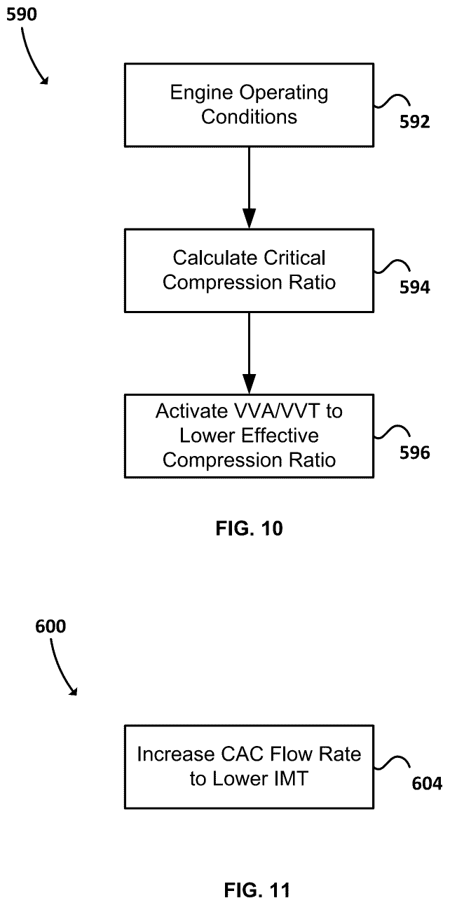

Referring now to FIG. 10, there is shown a flow chart of an algorithm 590 that can be employed for mitigation strategy 540 in algorithm 500 of FIG. 6. One or more engine operating condition parameters collected in step 592 are employed to calculate a critical compression ratio in step 594. The critical compression ratio is the minimum compression ratio required for autoignition in chamber 285 to occur and is a function of one or more engine operating condition parameters, such as one or more of fuel type or composition, ICT, IMP, IMT, EGR concentration, engine speed, and engine load. The effective compression ratio of internal combustion engines 10 or 11 is adjusted in step 596 such that the effective compression ratio is less than the critical compression ratio thereby preventing autoignition from occurring in chamber 285. By reducing the effective compression ratio, the pressure and temperature conditions in chamber 285 are no longer suitable for autoignition of the fuel-air mixture therein. The effective compression ratio can be changed by adjusting the valve timing of intake valve 110 by way of the VVT or VVA system. The amount by which the intake valve timing is adjusted is a function of the critical compression ratio. Returning to FIG. 6, standard engine map 530 includes a quantity of main fuel to be injected and ignited (either by forced ignition such as a pilot fuel or by autoignition) in the context of algorithm 590 seen in FIG. 10 that adjusts the effective compression ratio. A quantity of main fuel injected and/or the timing of main fuel injection in modified engine map 550 can be adjusted compared to standard engine map 530 since the thermal efficiency of engines 10 and 11 changes when the effective compression ratio changes. For example, when the effective compression ratio is decreased the fueling quantity of the main fuel is increased to compensate for the decrease in in power output. The ignition delay can also change when the effective compression ratio changes such that the start of injection timing may need to be corrected to maintain a preferred combustion timing.

Referring now to FIG. 11, there is shown a flow chart of an algorithm 600 that can be employed for mitigation strategy 540 in the algorithm 500 of FIG. 6. At step 604, a coolant flow rate through the charge-air-cooler (CAC) is increased to lower the IMT (and consequently ICT) such that the temperature within chamber 285 is reduced below the autoignition temperature. In the context of algorithm 600, the ICT at the beginning of the compression stroke is reduced when the IMT is reduced and is increased when the IMT is increased. The coolant flow rate increase can be a function of one or more of the critical crank angle, the compression ratio, current IMT, current ICT, current IMP, the engine speed, and the engine load. The charge-air-cooler is a heat exchanger that cools intake air compressed by the turbocharger (not shown in FIG. 1 or 3) before the turbo-compressed intake air is fluidly communicated into an intake manifold (not shown) and intake port 100. The response time of lowering IMT and ICT by way of increasing the coolant flow rate through the CAC can require several combustion cycles to complete. Accordingly, the technique of algorithm 600 can be operated in a predictive manner by lowering the IMT before autoignition in chamber 285 becomes a problem. The prediction of when to starting lowering IMT can be based on current values and a history of values of one or more of the engine operating condition parameters. In contrast, either the techniques of injecting the mitigation quantity of main fuel and adjusting intake valve timing can prevent autoignition within the combustion cycle that these techniques are first used. As the IMT is adjusted, it can be periodically updated in step 520 (seen in FIG. 6) for determining whether autoignition is possible in chamber 285. Returning to FIG. 6, standard engine map 530 includes a quantity of main fuel to be injected and ignited (either by forced ignition like a pilot fuel or by autoignition) in the context of algorithm 600 seen in FIG. 11 that adjusts IMT. A quantity of main fuel injected and/or the timing of main fuel injection in modified engine map 550 can be adjusted compared to standard engine map 530 to compensate for the different pressure and temperature environment present in combustion chamber 20 due to changes in IMT. For example, higher IMT in general leads to faster ignition and lower thermal efficiency, such that to maintain the same engine power output, the fueling quantity of main fuel needs to be increased and start of injection timing delayed.

In other embodiments, the mitigation strategies for reducing the likelihood and preferably preventing autoignition in chamber 285 disclosed in algorithms 560, 590, and 600 can be operated in harmony together to improve the effectiveness of preventing autoignition in chamber 285. As an example, algorithm 590 in FIG. 10 (adjusting the effective compression ratio) can be performed in parallel with algorithm 600 in FIG. 11 (adjusting IMT). As another example, algorithm 590 in FIG. 10 can be performed in series with algorithm 560 in FIG. 7 (performing a mitigation injection). One advantage in combining algorithm 590 with another one of the algorithms 560 or 600, is that reducing the effective compression ratio of internal combustion engines 10 and 11 also reduces the thermal efficiency of these engines, thereby reducing fuel economy and reducing peak power. By combining algorithm 590 with algorithm 560 or 600 the effective compression ratio does not have to be reduced as much to prevent autoignition in chamber 285. In some circumstances, the effective compression ratio may not be able to be reduced enough to prevent autoignition, and in these circumstances it is advantages to combine algorithm 590 (reducing the effective compression ratio) with either algorithm 560 (performing mitigation injections) or 600 (reducing IMT) to reduce and preferably prevent autoignition in chamber 285.

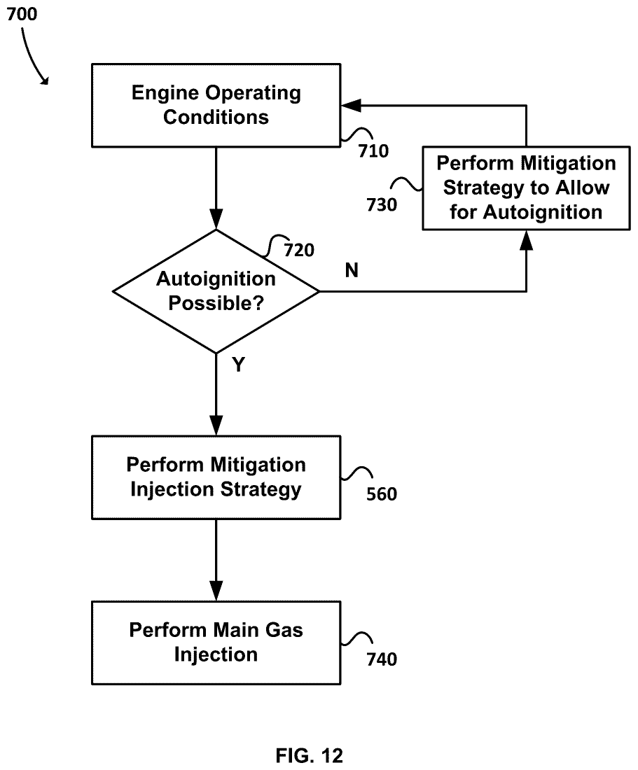

Referring now to FIG. 12, there is shown algorithm 700 for reducing and preferably preventing autoignition in chamber 285 that can be employed for operating internal combustion engine 10 in a monofuel mode that does not require a pilot fuel to ignite the main fuel or can be employed for operating internal combustion engine 11 that is a monofuel engine. One or more engine operating condition parameters 710, including the compression ratio, fuel type or composition, ICT, IMT, IMP, EGR concentration, engine speed and, engine load are employed in step 720 to determine whether autoignition is possible in combustion chamber 20. In the event autoignition is not possible, control is transferred to step 730 where an autoignition-enhancing mitigation strategy is performed to create the conditions possible for autoignition in combustion chamber 20. In the event autoignition is possible in combustion chamber 20, control is transferred step 560 (seen in detail in FIG. 7) where the mitigation injection strategy that prevents autoignition from occurring in chamber 285 is performed, which includes calculating the critical crank angle, calculating the mitigation injection quantity, and performing the mitigation injection. Typically, autoignition is possible in chamber 285 when it is possible in combustion chamber 20. Accordingly, steps are taken in algorithm 700 to reduce and preferably prevent autoignition from occurring in chamber 285 while allowing it to occur in combustion chamber 20. This is accomplished by performing the mitigation injection strategy (that is, algorithm 560 seen in FIG.

7) before a main gas injection is performed in step 740. A quantity of the main gas injection is determined by taking into consideration the quantity of the mitigation injection. The mitigation injection can also perform the function of igniting and combusting within combustion chamber 20 to create a more optimal environment (in terms of pressure and temperature) within combustion chamber 20 for igniting the main fuel from the main gas injection.

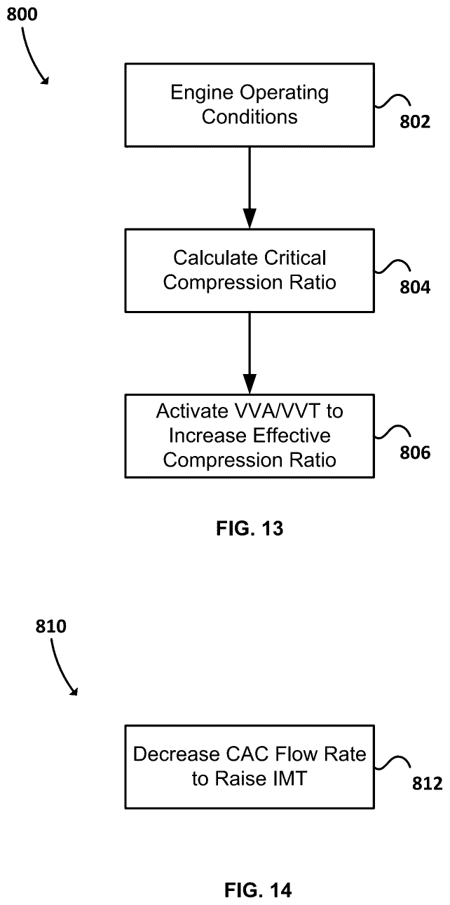

With reference to FIG. 13, algorithm 800 that adjusts the effective compression ratio to create the conditions that allow for autoignition can be employed for the autoignition-enhancing mitigation strategy 730 seen in FIG. 12. One or more engine operating condition parameters 802 such as fuel type or composition, ICT, IMT, IMP, EGR concentration, engine speed and, engine load is employed to calculate the critical compression ratio in step 804, and the effective compression ratio is adjusted in step 806 to be, if possible, equal to or greater than the critical compression ratio. In some circumstances the critical compression ratio may be greater than the geometric compression ratio such that it is not possible to increase the effective compression ratio beyond the geometric compression ratio. In this circumstance, a different technique or secondary measure is required to create the conditions necessary for autoignition in combustion chamber 20. With reference to FIG. 14, algorithm 810 can be employed alternatively or additionally as the autoignition-enhancing mitigation strategy 730 seen in FIG. 12. In step 812 the coolant flow rate through the charge-air-cooler (not shown) is decreased, which effectively increases IMT by reducing the cooling of turbo-compressed intake air. The ICT at the beginning of the compression stroke increases when the IMT increases. The increase in IMT and ICT can take several engine cycles to complete, and in this regard if an immediate need to create the conditions for autoignition is required the former technique of algorithm 800 where the effective compression ratio is adjusted is preferred. In other embodiments, the techniques of algorithms 800 (increasing the effective compression ratio) and 810 (increasing IMT and ICT) can be employed together, and typically in parallel.

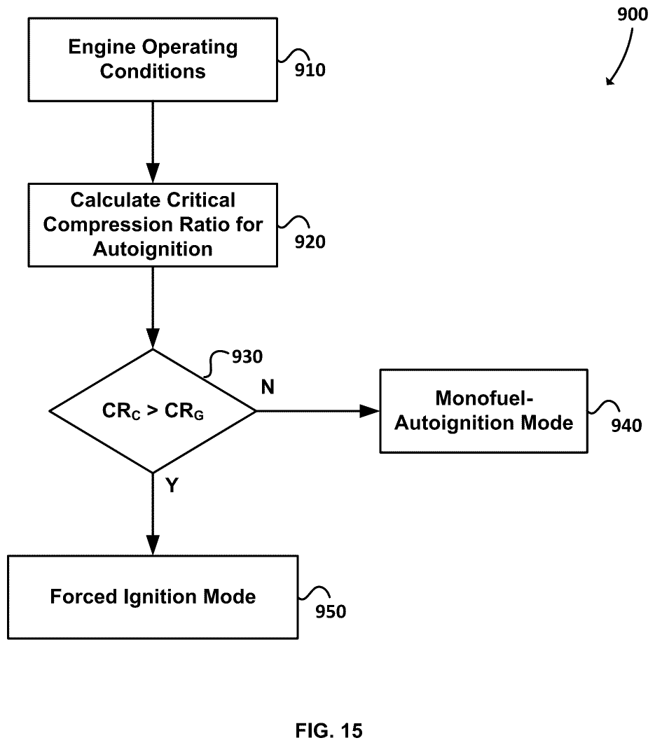

Referring now to FIG. 15, there is shown algorithm 900 for determining whether to operate engine 10 in either a monofuel-autoignition mode or a forced ignition mode. One or more engine operating condition parameters 910 such as the fuel type or composition, IMT, IMP, EGR concentration, engine speed, and engine load are employed in step 920 to determine the critical compression ratio CR_{C}, which is then compared against the geometrical compression ratio CR_{G} in step 930. The monofuel-autoignition mode 940 is selected when the critical compression ratio is not greater than the geometrical compression ratio, and the forced ignition mode 950 is selected when the critical compression ratio is greater than the geometrical compression ratio. In the forced ignition mode, another means is employed to ignite the main fuel, such as employing a pilot fuel in the embodiment of engine 10, or in other embodiments a spark plug, a glow plug or other heated surface. A pilot fuel such as diesel fuel has a higher cetane number than the main fuel and is therefore ignitable under temperature and pressure conditions where the main fuel is not ignitable.

Boost from a turbocharger influences inlet manifold pressure. Boost pressure can have a mild effect on ignition delay time and consequently can influence autoignition of the main fuel where increasing boost pressure increases the likelihood of autoignition in combustion chamber 20 and chamber 285 and decreasing boost pressure decreases the likelihood of autoignition therein. Lowering boost pressure can lead to higher exhaust temperature and lower efficiency. The upper limit of the boost pressure is controlled by the turbine compressor efficiency, peak cylinder pressure and available enthalpy in the exhaust, so there is very limited range within which boost can be changed. The intake manifold temperature on the other hand has a much stronger effect on autoignition of the main fuel.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

We claim:

1. An apparatus for managing ignition in a chamber within an in-cylinder injector that introduces a fuel directly into a combustion chamber of an internal combustion engine, the chamber including at least one injection hole and in fluid communication with the combustion chamber through the at least one injection hole, the apparatus comprising a controller operatively connected with the in-cylinder injector and programmed to:
selectively actuate the in-cylinder injector to inject the fuel directly into the combustion chamber;
determine whether autoignition is possible within the chamber as a function of engine operating parameters; and
perform a mitigation strategy to prevent autoignition within the chamber of the in-cylinder injector when autoignition is possible.

2. The apparatus as claimed in claim 1, wherein the controller is further programmed to employ a standard engine map when autoignition is not possible, and to employ a modified engine map when autoignition is possible.

3. The apparatus as claimed in claim 1, wherein the engine operating parameters are one or more of geometric compression ratio, effective compression ratio, fuel type, fuel composition, intake charge temperature, inlet manifold pressure, inlet manifold temperature, exhaust gas recirculation concentration, engine speed, and engine load.

4. The apparatus as claimed in claim 1, wherein in performing the mitigation strategy the controller is programmed to:
determine a critical crank angle during a compression stroke when autoignition becomes possible in the chamber;
determine a mitigation quantity of the fuel required to be injected before the critical crank angle to prevent autoignition in the chamber; and
actuate the in-cylinder injector to perform a mitigation injection of the mitigation quantity of the fuel before the critical crank angle is reached by a piston traveling in the combustion chamber during the compression stroke.

5. The apparatus as claimed in claim 4, wherein the mitigation quantity of the fuel prevents autoignition in the chamber at least until a main injection of the fuel occurs later during the compression stroke.

6. The apparatus as claimed in 1, wherein in performing the mitigation strategy the controller is programmed to:
determine a critical compression ratio that creates a pressure and temperature environment in the chamber suitable for autoignition; and
adjust an effective compression ratio such that the effective compression ratio is less than the critical compression ratio.

7. The apparatus as claimed in claim 6, wherein the critical compression ratio is calculated as a function of at least one engine operating parameter selected from the group consisting of fuel type, fuel composition, intake charge temperature, inlet manifold pressure, inlet manifold temperature, exhaust gas recirculation concentration, engine speed, and engine load.

8. The apparatus as claimed in claim 1, wherein in performing the mitigation strategy the controller is programmed to increase a coolant flow through a charge-air-cooler to decrease an inlet manifold temperature or an intake charge temperature at the beginning of a compression stroke.

9. The apparatus as claimed in claim 1, wherein the controller is further programmed to perform a second mitigation strategy when autoignition of the fuel is not possible within the combustion chamber.

10. The apparatus as claimed in claim 9, wherein in performing the second mitigation strategy the controller is programmed to:
determine a critical compression ratio that creates a pressure and temperature environment in the combustion chamber suitable for autoignition; and
adjust an effective compression ratio such that the effective compression ratio is greater than or equal to the critical compression ratio.

11. The apparatus as claimed in claim 9, wherein in performing the second mitigation strategy the controller is programmed to decrease a coolant flow through a charge-air-cooler to increase an inlet manifold temperature or an intake charge temperature at the beginning of a compression stroke.

12. A method for managing ignition in a chamber within an in-cylinder injector that introduces a fuel directly into a combustion chamber of an internal combustion engine, the chamber including at least one injection hole and in fluid communication with the combustion chamber through the at least one injection hole, the method comprising:
determining whether autoignition is possible within the chamber as a function of engine operating parameters; and
performing a mitigation strategy to prevent autoignition within the chamber of the in-cylinder injector when autoignition is possible.

13. The method as claimed in claim 12, wherein a standard engine map is employed when autoignition is not possible, and a modified engine map is employed when autoignition is possible.

14. The method as claimed in claim 12, wherein the engine operating parameters are one or more of geometric compression ratio, effective compression ratio, fuel type, fuel composition, intake charge temperature, inlet manifold pressure, inlet manifold temperature, exhaust gas recirculation concentration, engine speed, and engine load.

15. The method as claimed in claim 12, wherein the mitigation strategy comprises:
determining a critical crank angle during a compression stroke when autoignition becomes possible in the chamber;
determining a mitigation quantity of the fuel required to be injected before the critical crank angle to prevent autoignition in the chamber; and
performing a mitigation injection of the mitigation quantity of the fuel before the critical crank angle is reached by a piston traveling in the combustion chamber during the compression stroke.

16. The method as claimed in claim 15, wherein the mitigation quantity of the fuel prevents autoignition in the chamber at least until a main injection of main fuel occurs later during the compression stroke.

17. The method as claimed in 12, wherein the mitigation strategy comprises:
determining a critical compression ratio that creates a pressure and temperature environment in the chamber suitable for autoignition; and
adjusting an effective compression ratio such that the effective compression ratio is less than the critical compression ratio.

18. The method as claimed in claim 17, wherein the critical compression ratio is calculated as a function of at least one engine operating parameter selected from the group consisting of fuel type, fuel composition, intake charge temperature, inlet manifold pressure, inlet manifold temperature, exhaust gas recirculation concentration, engine speed, and engine load.

19. The method as claimed in claim 12, wherein the mitigation strategy comprises increasing a coolant flow through a charge-air-cooler to decrease an inlet manifold temperature or an intake charge temperature at the beginning of a compression stroke.

20. The method as claimed in claim 12, wherein a second mitigation strategy is performed when autoignition of the fuel is not possible within the combustion chamber.

21. The method as claimed in claim 20, the second mitigation strategy comprises:
determining a critical compression ratio that creates a pressure and temperature environment in the combustion chamber suitable for autoignition; and
adjusting an effective compression ratio such that the effective compression ratio is greater than or equal to the critical compression ratio.

22. The method as claimed in claim 20, the second mitigation strategy comprises decreasing a coolant flow through a charge-air-cooler to increase an inlet manifold temperature or an intake charge temperature at the beginning of a compression stroke.
